(19) United States
(12) Patent Application Publication
(10) Pub. No.: US 2025/0304187 A1
(43) Pub. Date: Oct. 2, 2025

(54) VEHICLE WITH A VEHICLE BODY HAVING AN INSTRUMENT PANEL CROSS BEAM AND METHOD FOR ASSEMBLING AN INSTRUMENT PANEL CROSS BEAM ON A VEHICLE BODY

(71) Applicant: Ford Global Technologies, LLC, Dearborn, MI (US)

(72) Inventors: Simon Eberhard, Cologne (DE); Nazim Djoudi, Cologne (DE); Erik James Garland, Commerce Township, MI (US); Robin Advena, Cologne (DE)

(73) Assignee: Ford Global Technologies, LLC, Dearborn, MI (US)

(21) Appl. No.: 19/052,817

(22) Filed: Feb. 13, 2025

(30) Foreign Application Priority Data
Mar. 26, 2024 (EP) 24166525.6

(51) Int. Cl. B62D 25/14; B60R 7/06; B62D 25/20; B62D 27/02; B62D 27/06

(52) U.S. Cl. CPC B62D 25/145; B60R 7/06; B62D 25/2018; B62D 27/026; B62D 27/065

(57) ABSTRACT

A motor vehicle has a vehicle body with side parts opposite one another at a distance and with a vehicle floor. An instrument panel cross beam is arranged between the side parts and attached thereto and a console is arranged on the vehicle floor and attached thereto. At least one support strut extends from the instrument panel cross beam in the direction of the vehicle floor, wherein the console is located in the load path between the at least one support strut and the vehicle floor.

### CROSS-REFERENCE TO RELATED APPLICATION

This application claims foreign priority benefits under 35 U.S.C. § 119 (a)-(d) to European Application No. 24166525.6 filed Mar. 26, 2024, which is hereby incorporated by reference in its entirety.

### FIELD OF THE DISCLOSURE

The present disclosure generally relates to vehicle instrument panel cross beam assemblies, and more particularly to a motor vehicle body having an instrument panel cross beam assembly and a method for assembling the instrument panel cross beam on the vehicle body.

### BACKGROUND OF THE DISCLOSURE

Modern motor vehicles commonly have an instrument panel cross beam that is typically an assembly of sheet metal and plastic parts that forms a structural unit or skeleton of the instrument panel or dashboard. The instrument panel cross beam is generally arranged and attached to the vehicle body between side parts of the vehicle body next to front support pillars on a driver and passenger side of the vehicle and attached to a vehicle floor of the vehicle body in the area of a center line of the vehicle. Various elements of the instrument panel are commonly attached to and held by the instrument panel cross beam.

Furthermore, modern vehicles also typically have a floor console, which is a structural element with its own structural units, supports and brackets. The floor console is usually arranged along the vehicle centerline between the front seats of the vehicle and attached to the floor of the vehicle body. It would be desirable to provide an instrument panel cross beam assembly on a motor vehicle that offers a sturdy structure with enhanced efficiencies.

### SUMMARY OF THE DISCLOSURE

According to a first aspect of the present disclosure, a motor vehicle has a vehicle body having side parts opposite one another at a distance, a vehicle floor, an instrument panel cross beam arranged between the side parts and attached to the side parts, a console arranged on the vehicle floor and attached to the vehicle floor and at least one support strut extending from the instrument panel cross beam in a direction of the vehicle floor. The console is located in a load path between the at least one support strut and the vehicle floor.

Embodiments of the first aspect of the present disclosure can include any one or a combination of the following features:
the console is a center console;
the at least one support strut is configured as a stiffening strut;
the at least one support strut is attached to the console via a distal end portion;
the distal end portion of the at least one support strut is arranged parallel to a part of the console, which is supported on the vehicle floor, and is attached to the vehicle floor, or wherein the distal end portion of the at least one support strut is arranged parallel to a side part of the console, which is supported on the vehicle floor, and is attached to the vehicle floor;
the distal end portion is attached to the console by at least one of a screw connection, a riveted connection, a welded connection and an adhesive connection; and
the load path between the at least one support strut and the console is established via at least two attachment points of the at least one support strut on the console.

According to a second aspect of the present disclosure, a motor vehicle has a vehicle body having side parts opposite one another at a distance, a vehicle floor, an instrument panel cross beam arranged between the side parts and attached to the side parts, and a console arranged on the vehicle floor and attached to the vehicle floor. The console is a center console. A support strut extends from the instrument panel cross beam in a direction of the vehicle floor. The console is located in a load path between the support strut and the vehicle floor. The support strut is configured as a stiffening strut.

Embodiments of the second aspect of the present disclosure can include any one or a combination of the following features:
the support strut is attached to the console via a distal end portion;
the distal end portion of the support strut is arranged parallel to a part of the console, which is supported on the vehicle floor, and is attached to the vehicle floor, or wherein the distal end portion of the support strut is arranged parallel to a side part of the console, which is supported on the vehicle floor, and is attached to the vehicle floor;
the distal end portion is attached to the console by at least one of a screw connection, a riveted connection, a welded connection and an adhesive connection; and
the load path between the support strut and the console is established via at least two attachment points of the support strut on the console.

Further, subject of the disclosure is a method for assembling an instrument panel cross beam on a vehicle body of a vehicle, in particular a motor vehicle. The method comprises at least the following steps:
arranging the instrument panel cross beam between spaced-apart opposite side parts of the vehicle body and attaching it thereto, and
arranging a console on a vehicle floor of the vehicle body and attaching it thereto, wherein a load path is established between at least one support strut, which extends from the instrument panel cross beam towards the vehicle floor, and the console.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partial perspective view of a vehicle body of a motor vehicle having an instrument panel cross beam, according to one embodiment in a first assembly state;

FIG. 2 is a further partial perspective view of the vehicle body shown in FIG. 1 in a second assembly state; and

FIG. 3 is a still further partial perspective view of the vehicle body shown in FIG. 1 in a third assembly state.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

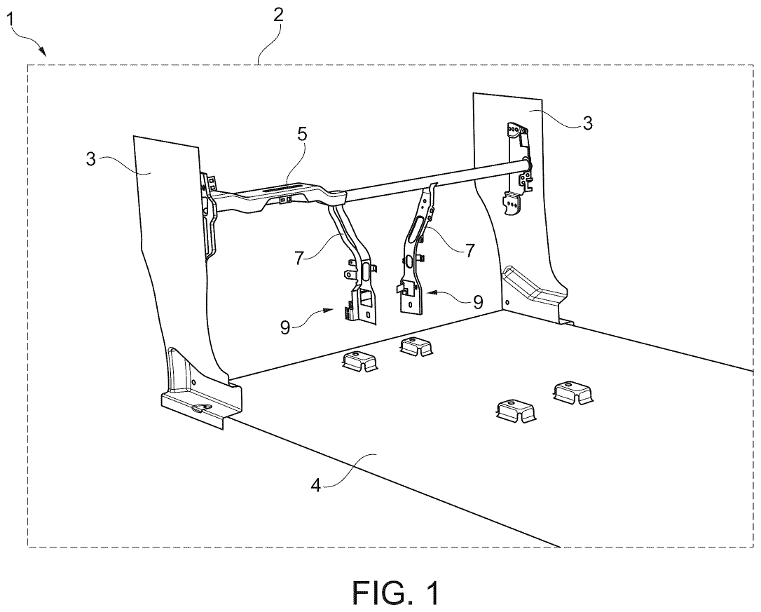

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a motor vehicle having an instrument panel cross beam and method of assembling the instrument panel cross beam. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

It should be noted that the features listed individually in the following description can be combined with each other in any technically meaningful way and demonstrate further embodiments of the invention. The description additionally characterizes and specifies the invention, in particular in connection with the figures.

It should also be noted that a conjunction “and/or” used herein between two features and linking them together is always to be interpreted such that in a first embodiment of the subject matter according to the invention only the first feature may be present, in a second embodiment only the second feature may be present and in a third embodiment both the first and the second feature may be present.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Equivalent parts are generally denoted by the same reference signs in the figures and therefore generally may only be described once.

FIG. 1 is a schematic representation of a partial perspective view of an embodiment of a vehicle 1, particularly a motor vehicle, according to one embodiment in a first assembly state. The motor vehicle 1 has a schematically indicated vehicle body 2 with two side parts 3 opposite each other at a distance and a vehicle floor 4. An instrument panel cross beam 5 is illustrated arranged between the two side parts 3. The instrument panel cross beam 5 is attached at both ends to one of the two side parts 3.

FIG. 1 shows the assembly state in which the instrument panel cross beam 5 is arranged and fastened between the two opposing side parts 3 of the vehicle body 2.

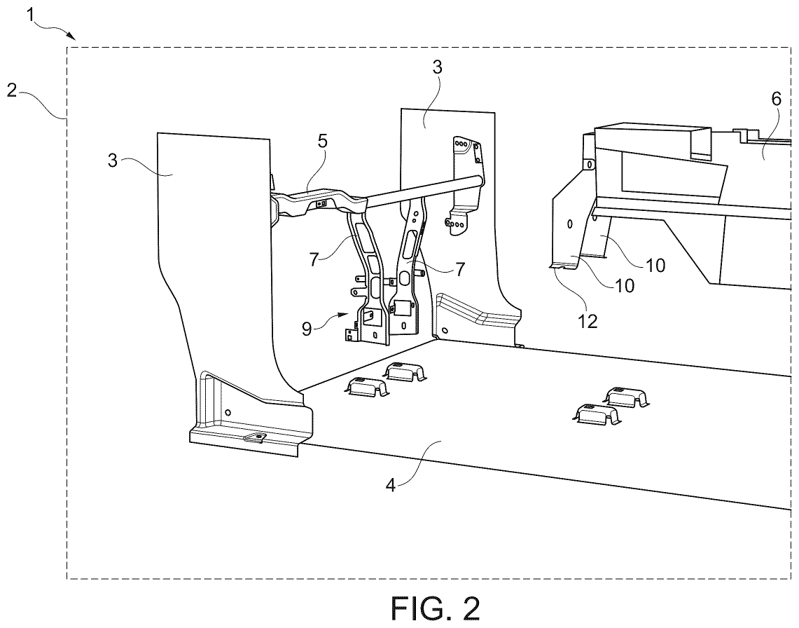

FIG. 2 is a schematic representation of a further perspective partial view of the motor vehicle 1 illustrated in FIG. 1 in a second assembly state, in which a console 6, which is configured as a center console in the present embodiment, is configured to be arranged on the vehicle floor 4 of the vehicle body 2. It can also be seen that at least one, in this embodiment, two support struts 7 extend from the instrument panel cross beam 5 towards the vehicle floor 4.

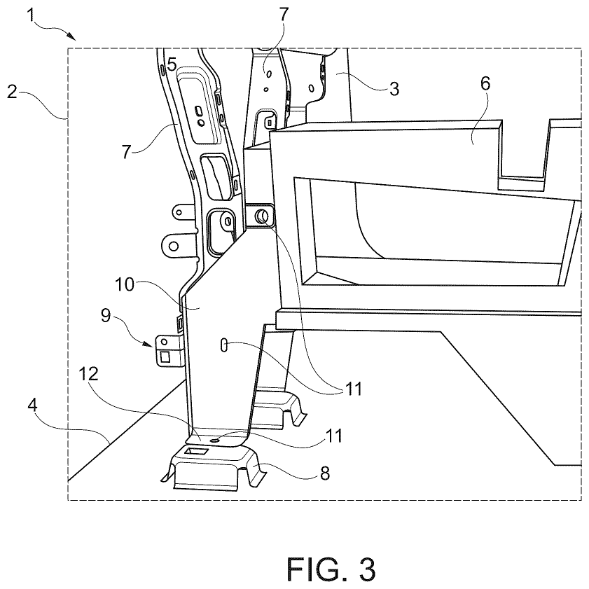

FIG. 3 is a schematic representation of yet another partial perspective view of the motor vehicle 1 illustrated in FIG. 1 in a third assembly state, in which the console 6 is attached to the vehicle floor 4. For example, the console 6 can be screwed, riveted, welded and/or bonded to the vehicle floor 4 at corresponding floor-side fastening elements 8. In order not to obstruct the view of the main components, the side part 3 of the vehicle body 2 in the foreground is omitted in the side view shown. Only the opposite side part 3 can be seen in the background of the illustration.

Reference is made to FIGS. 1-3 in the following description. It can be seen that the support struts 7 each have a distal end portion 9. The support struts 7 are each attached to the console 6 via this distal end portion 9, as can be clearly seen in FIG. 3. This establishes a load path between each of the support struts 7 extending from the instrument panel cross beam 5 towards the vehicle floor 4 and the console 6. The console 6 is thus in the load path between the support struts 7 and the vehicle floor 4. In FIGS. 1 and 2, it can be clearly seen that the support struts 7 are shorter in length than they would be to bridge a distance between the instrument panel cross beam 5 and the vehicle floor 4. This gap is closed by the console 6, as shown in FIG. 3.

In FIG. 2, two side parts 10 of the console 6 can be seen, via which the console 6 is supported in its front section on the vehicle floor 4 as shown in FIG. 3 and fastened via the fastening elements 8 in the later mentioned manner. It can also be seen from FIG. 3 that the distal end portion 9 of each support strut 7 runs essentially parallel to the corresponding side part 10 of the console 6. In this arrangement, the respective distal end portions 9 of the support struts 7 are attached to the corresponding side parts 10 of the console 6, for example screwed, riveted, welded and/or bonded to the side parts 10.

In the illustrated exemplary vehicle 1, two attachment points 11 are provided for the force-conducting connection between the respective support struts 7 and the corresponding side parts 10 of the console 6. As mentioned, the attachment points 11 can be designed as at least one of a screw, rivet, welded and adhesive connection. A bent end section 12 is further illustrated arranged on each of the side parts 10, via which the side parts 10 rest on the fastening elements 8. The bent end section 12 is generally configured as a fastening flange, according to one example. Indicated is an attachment point 11 for fastening the bent end section 12 to the fastening elements 8 with contacting surfaces, according to one embodiment.

The motor vehicle 1 disclosed herein and the method disclosed herein are not limited to the embodiments disclosed herein, but also may comprise further embodiments having the same or similar effect, which result from technically expedient further combinations of the features of the motor vehicle or the method described herein. In particular, the features and combinations of features mentioned hereinbefore in the general description and the description of the figures and/or shown in the figures alone are usable not only in the respective combinations explicitly stated herein, but also in other combinations or in a stand-alone position, without leaving the scope of the present disclosure. Although it may be preferred to arrange the distal end portion parallel to a side part of the console and to attach it thereto, it is in the sense of the disclosure, that the distal end portion could be fixed to any other part of the console, not only in the y-direction but also in any orientation on the vehicle environment according to other embodiments.

A motor vehicle is disclosed with a vehicle body having an instrument panel cross beam and a method for assembling an instrument panel cross beam on a vehicle body, which enable a sturdy structure with a reduced use of materials and a lower weight or a reduction in manufacturing operations during an assembly process. Manufacturing efficiencies are also to be reduced.

The disclosure relates to a vehicle, in particular a motor vehicle such as a passenger car, bus, truck and the like, which has a vehicle body. The vehicle body, in turn, has opposite side parts spaced apart from one another in a transverse direction of the vehicle and a vehicle floor. An instrument panel cross beam is arranged between the side parts and attached to the respective side parts. A console is arranged on the vehicle floor and attached to the vehicle floor. At least one support strut extends from the instrument panel cross beam towards the vehicle floor. According to the disclosure, the console is located in the load path between the support strut and the vehicle floor.

In other words, the support strut has no direct force-conducting connection to the vehicle floor. The load path, i.e., the path taken by the force to support the instrument panel cross beam on the vehicle floor through the support strut, runs via structural elements of the console. The length of the support strut can be shorter, as it no longer has to completely bridge the distance between the instrument panel cross beam and the vehicle floor. Part of this distance is now bridged by the console arranged between the vehicle floor and the support strut. The console or part of the console is used to connect the support strut to the vehicle floor in a force-conducting manner. On the one hand, this saves material and connecting elements and reduces weight. On the other hand, assembling the instrument panel cross beam on the vehicle body is simplified, as the reduced number of connecting and fastening elements eliminates assembly steps.

In one embodiment, the console is a so-called center console. The center console is to be understood as a part of the instrument panel of the motor vehicle that begins approximately at the knee height of a person sitting in the vehicle between the two front footwells and extends to the position of an armrest between front seats of the vehicle.

According to one embodiment, the at least one support strut is designed as a so-called stiffening strut. The stiffening strut has the effect of stiffening the instrument panel cross beam in an extreme event of the vehicle and prevents or reduces uncontrolled, deep penetration of the instrument panel into the passenger compartment of the vehicle by reliably transferring movement forces from the instrument panel cross beam via the console into the vehicle floor. On the other hand, the stiffening strut dissipates movement energy in the extreme event of the vehicle by use of a deformation specifically determined by the design.

According to further advantageous embodiments, the support strut is attached to the console via a distal end portion.

In one embodiment, the distal end portion is arranged parallel to a part of the console, which is supported on the vehicle floor, and is attached to the part. In a further embodiment, the distal end portion is arranged parallel to a side part of the console, which is supported on the vehicle floor, and is attached to the side part This means that the support strut does not guide the load path via a console structure extending essentially in a transverse direction of the vehicle, but via the side parts of the console extending essentially in a vertical direction of the vehicle. The support strut therefore does not couple to the top of the console, but laterally to the side part. Accordingly, the side parts are essentially not subjected to bending by the load path, but to a compressive force, which enables greater mechanical stability and resistance of the console for reliable force absorption with less material required. Although it may be preferred to arrange the distal end portion parallel to a side part of the console and to to attach it thereto, it is in the sense of the disclosure, that the distal end portion could be fixed to any other part of the console, not only in the y-direction but also in any orientation on the vehicle environment.

According to other advantageous embodiments, the distal end portion is attached to the console by use of a screw connection, riveted connection, welded connection and/or adhesive connection. Screwed or riveted connections represent a positive connection between the support strut and the console in terms of the load path and enable a well-defined force transmission between the two components. In contrast, welded and adhesive connections represent a material connection between the support strut and the console, in which the force distribution can be distributed over a larger attachment surface.

It may be particularly preferable that the load path between the support strut and the console is established via at least two attachment points of the support strut on the console, so that the stress on the connection occurring during the introduction of force is evenly distributed over the at least two attachment points. In addition, moments acting between the support strut and the console are better absorbed by at least two attachment points. The attachment points can, for example, be formed via screw, rivet, welded and/or adhesive connections, which connect the support strut to the console.

It is to be understood that definitions of terms relating to the claimed method and relating to the effects and advantages of features of the claimed method can be fully referred to the disclosure of corresponding definitions, effects and advantages of the vehicle, and vice versa. A repetition of explanations of correspondingly identical features, their effects and advantages can thus be dispensed with in favor of a more compact description, without such omissions having to be construed as a limitation for the disclosure.

According to one embodiment, the support strut is attached to the console via a distal end portion. According to a further embodiment, the distal end portion of the support strut may be arranged to extend parallel to and be attached to a portion of the console which is supported on the vehicle floor. According to further embodiments, the distal end portion of the support strut may be arranged to extend parallel to and be attached to a side portion of the console which is supported on the vehicle floor. Although it may be preferred to arrange the distal end portion parallel to a side part of the console and to attach it thereto, it is in the sense of the disclosure, that the distal end portion could be fixed to any other part of the console, not only in the y-direction but also in any orientation on the vehicle environment.

According to further embodiments, the distal end portion may be bolted, riveted, welded and/or bonded to the console.

Other advantageous embodiments provide for the load path between the support strut and the console to be established via at least two attachment points of the support strut to the console, for example via screw, rivet, welded and/or adhesive connections which connect the support strut to the console.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A motor vehicle comprising:
a vehicle body having side parts opposite one another at a distance;
a vehicle floor;
an instrument panel cross beam arranged between the side parts and attached to the side parts;
a console arranged on the vehicle floor and attached to the vehicle floor; and
at least one support strut extending from the instrument panel cross beam in a direction of the vehicle floor, wherein the console is located in a load path between the at least one support strut and the vehicle floor.

2. The vehicle according to claim 1, wherein the console is a center console.

3. The vehicle according to claim 1, wherein the at least one support strut is configured as a stiffening strut.

4. The vehicle according to claim 3, wherein the at least one support strut is attached to the console via a distal end portion.

5. The vehicle according to claim 4, wherein the distal end portion of the at least one support strut is arranged parallel to a part of the console, which is supported on the vehicle floor, and is attached to the vehicle floor, or wherein the distal end portion of the at least one support strut is arranged parallel to a side part of the console, which is supported on the vehicle floor, and is attached to the vehicle floor.

6. The vehicle according to claim 5, wherein the distal end portion is attached to the console by at least one of a screw connection, a riveted connection, a welded connection and an adhesive connection.

7. The vehicle according to claim 1, wherein the load path between the at least one support strut and the console is established via at least two attachment points of the at least one support strut on the console.

8. A motor vehicle comprising:
a vehicle body having side parts opposite one another at a distance;
a vehicle floor;
an instrument panel cross beam arranged between the side parts and attached to the side parts;
a console arranged on the vehicle floor and attached to the vehicle floor, wherein the console is a center console; and
a support strut extending from the instrument panel cross beam in a direction of the vehicle floor, wherein the console is located in a load path between the support strut and the vehicle floor, wherein the support strut is configured as a stiffening strut.

9. The vehicle according to claim 8, wherein the support strut is attached to the console via a distal end portion.

10. The vehicle according to claim 9, wherein the distal end portion of the support strut is arranged parallel to a part of the console, which is supported on the vehicle floor, and is attached to the vehicle floor, or wherein the distal end portion of the support strut is arranged parallel to a side part of the console, which is supported on the vehicle floor, and is attached to the vehicle floor.

11. The vehicle according to claim 10, wherein the distal end portion is attached to the console by at least one of a screw connection, a riveted connection, a welded connection and an adhesive connection.

12. The vehicle according to claim 8, wherein the load path between the support strut and the console is established via at least two attachment points of the support strut on the console.

13. A method for assembling an instrument panel cross beam on a vehicle body of a motor vehicle, comprising at least the steps of:
arranging the instrument panel cross beam between side parts of the vehicle body which are opposite one another at a distance and attaching the instrument panel cross beam to the side parts; and
arranging a console on a vehicle floor of the vehicle body and attaching the console to the vehicle floor, wherein a load path is established between at least one support strut extending from the instrument panel cross beam in a direction of the vehicle floor and the console.

14. The method according to claim 13, wherein the at least one support strut is attached to the console via a distal end portion.

15. The method according to claim 14, wherein the distal end portion of the at least one support strut is arranged parallel to a part of the console, which is supported on the vehicle floor, and is attached to the vehicle floor, or wherein the distal end portion of the support strut is arranged parallel to a side part of the console, which is supported on the vehicle floor, and is attached to the vehicle floor.

16. The method according to claim 15, wherein the distal end portion is screwed, riveted, welded and/or bonded to the console.

17. The method according to claim 13, wherein the load path between the at least one support strut and the console is established via at least two attachment points of the support strut on the console.
